(19) United States
(12) Patent Application Publication
(10) Pub. No.: US 2006/0086327 A1
(43) Pub. Date: Apr. 27, 2006

(54) Engine power assembly

(75) Inventors: Paul Lloyd Flynn, Fairview, PA (US); Jeffrey Scott Lebegue, Simpsonville, SC (US); John Patrick Dowell, Grove City, PA (US); Barry Record, Grove City, PA (US)

Correspondence Address: GERALD W. SPINKS, P. O. BOX 5242, GLACIER, WA, 98244, US

(73) Assignee: General Electric Company, Schenectady, NY (US)

(21) Appl. No.: 10/973,811

(22) Filed: Oct. 25, 2004

(51) Int. Cl. F02F 1/16

(52) U.S. Cl. 123/41.84

(57) ABSTRACT

A locomotive diesel engine, having a cylinder liner and a separate water jacket surrounding the cylinder liner, with a portion of the water jacket being positioned between the cylinder liner and the engine frame, where the cylinder liner is supported by the water jacket. An external shoulder on the cylinder liner can be supported by an internal flange in the water jacket, thereby eliminating direct contact between the cylinder liner and the engine frame. A coolant passage can be provided between the water jacket and the cylinder liner, at a point adjacent the topmost position of the top piston ring. An upper liner seal can be provided between the cylinder liner and the water jacket, above the coolant passage, and a lower liner seal can be provided between the cylinder liner and the engine frame, below the coolant passage. Coolant ports can be provided for coolant flow directly between the cylinder head and the water jacket, with seals in the coolant ports to seal the coolant, independently of the head gasket.

### CROSS REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention is in the field of locomotive diesel engines,
specifically as it relates to the engine components involved in coolant flow and heat removal from the structures surrounding the combustion chamber.

2. Background Art

There are several problems related to the way in which an engine frame, cylinder head, cylinder liner, and water jacket are assembled, in any internal combustion engine which utilizes a separate cylinder liner. One of these problems is the leakage of coolant. The mating surfaces between an engine block or cylinder liner and the related cylinder head are typically subject to some leakage of products of combustion, as well as coolant, especially in high compression diesel engines used for locomotive applications. These surfaces are commonly mated with a head gasket in between, and the head gasket is often subject to exposure to high temperature and high pressure combustion products from the combustion chamber, accelerating gasket wear and the attendant leakage of coolant and combustion products.

More specifically, it is typically necessary to provide for flow of engine coolant between the cylinder head and the area surrounding the cylinder liner, in order to remove excess heat from the area surrounding the combustion chamber. Flow passages between this area and the cylinder head are subject to some leakage of coolant, especially where the coolant passages are sealed only by the head gasket. This is because the head gasket is subjected to the aforementioned high combustion pressure and temperature, and the gasket can deteriorate as a result of this pressure and temperature. This deterioration of the head gasket can ultimately result in coolant leakage.

Another problem associated with this type of engine is the inefficient removal of excess heat from the area surrounding the combustion chamber, which can result in hot spots, stress concentrations, and accelerated component wear. Cooling must be provided to any component which forms a part of the combustion chamber, because these components are directly contacted by the high temperature products of combustion. In the type of engine being addressed, this requires providing cooling for the cylinder head and the cylinder liner. Typically, the same coolant is circulated in contact with the cylinder head and the cylinder liner, with flow between these two components and a heat removal device such as a radiator. In providing flow of the coolant to the area surrounding the cylinder liner, if the coolant flow is restricted to contact only with the portion of the cylinder liner below the topmost position of the top piston ring, the removal of excess heat from the combustion chamber can be inefficient. This is because the combustion initiates at the top of the combustion chamber, next to the cylinder head, above the topmost position of the top piston ring, and the top of the cylinder liner will typically be hotter than the lower portions. So, a lower efficiency of heat removal results from circulating the coolant in contact with a relatively low portion of the outer surface of the cylinder liner.

A further problem associated with this type of engine is accelerated wear of the structural components of the engine, which can result from the repetitive loads imposed on the components by repetitive firing of the cylinder. Specifically, the cylinder liner is typically held in position by being compressed between the cylinder head and an engine frame. In other words, the cylinder head and the engine frame are usually bolted together, with the cylinder liner clamped therebetween. Typically, the engine frame and the cylinder head also hold the water jacket in place relative to the cylinder liner. The cylinder liner can experience advanced wear where it abuts the engine frame, because of repetitive combustion loads on the cylinder liner.

### BRIEF SUMMARY OF THE INVENTION

The present invention includes an engine power assembly having a cylinder head, an engine frame, a cylinder liner, and a water jacket. The cylinder liner is supported by abutting the water jacket, which in turn abuts the engine frame. The cylinder liner does not directly abut the engine frame. This elimination of direct abutment of the cylinder liner against the engine frame minimizes the aforementioned wear of the cylinder liner.

Also, a coolant passage is provided between the water jacket and the cylinder liner, adjacent the top end of the cylinder liner at the topmost position of the top piston ring. This maximizes cooling by circulating coolant against the outer surface of the cylinder liner at the same height as the location of the initiation of combustion, which occurs at the top of the cylinder above the topmost position of the top piston ring.

Further, coolant ports are provided in the cylinder head and the top of the water jacket, to conduct coolant directly between the cylinder head and the water jacket, without passing through the cylinder liner or any other component. Seals are provided in these coolant ports, separate from the head gasket. These seals seal against coolant leakage between the cylinder head and the water jacket, without reliance on the head gasket.

Finally, seals are provided at the upper and lower portions of the cylinder liner, above and below the coolant passage. The upper seal seals between the cylinder liner and the water jacket, while the lower seal seals between the cylinder liner and the engine frame. A fire ring is provided between the combustion chamber and the head gasket, thus protecting the head gasket from accelerated wear by direct exposure to the high temperature products of combustion.

The novel features of this invention, as well as the invention itself, will be best understood from the attached drawings, taken along with the following description, in which similar reference characters refer to similar parts, and in which:

### BRIEF DESCRIPTION OF THE SEVERAL VIEWS OF THE DRAWINGS

FIG. 1 is a vertical section view of the apparatus of the present invention;

FIG. 2 is a transverse section view of a portion of the apparatus shown in FIG. 1;

FIG. 3 is a vertical section view of the portion of the apparatus shown in FIG. 2; and

FIG. 4 is a vertical section view of a portion of the apparatus shown in FIG. 3.

### DETAILED DESCRIPTION OF THE INVENTION

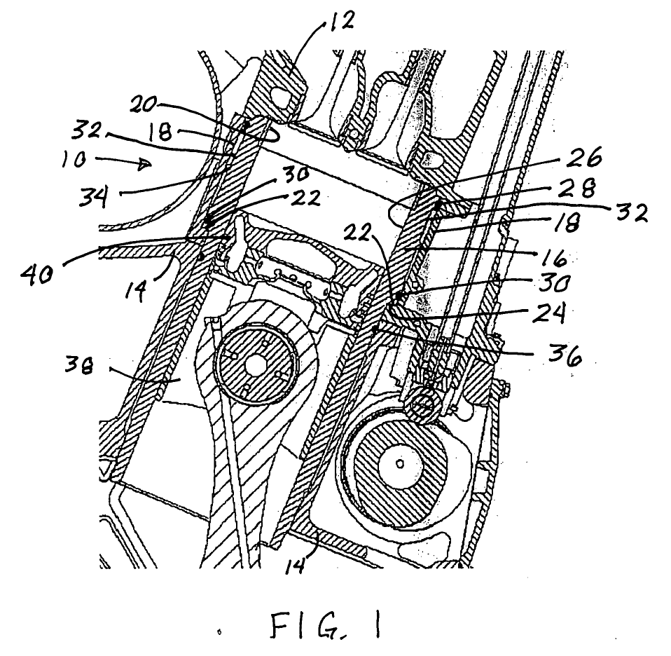

As shown in FIG. 1, a first embodiment of the apparatus 10 of the present invention includes a cylinder head 12, an engine frame 14, a cylinder liner 16, a strongback or water jacket 18, and a fire ring 20. An upwardly facing flange 22 can be provided on the internal surface of the water jacket 18, better seen in FIG. 3, and a downwardly facing shoulder 24 can be provided on the external surface of the cylinder liner 16. The shoulder 24 is designed to abut the flange 22, in order to support the cylinder liner 16 from the water jacket 18. The water jacket 18 is in turn supported by the engine frame 14. This avoids direct support of the cylinder liner 16 by the engine frame 14, thereby minimizing wear of the cylinder liner 16.

The fire ring 20 is provided at the joint between the cylinder liner 16 and the cylinder head 12, to protect the head gasket from damage by exposure to hot combustion gases. A piston 38 is shown at a lower position, for the sake of clarity. In operation, the piston 38 rises to an uppermost position at top dead center, where the upper piston ring 40 is positioned at approximately the height 26 shown relative to the cylinder liner 16. A coolant passage 32 is provided between the cylinder liner 16 and the water jacket 18. The coolant passage 32 extends at least as high as the uppermost position 26 of the piston ring 40. This provides a maximum cooling effect by circulating coolant against the outer surface of the cylinder liner 16 at the approximate height where combustion initiates. A baffle 34 on the external surface of the cylinder liner 16 extends into the coolant passage 32, to eliminate laminar flow and promote heat transfer away from the cylinder liner 16.

An upper liner seal 28 is provided in an upper groove on the external surface of the cylinder liner 16, to seal between the upper end of the cylinder liner 16 and the water jacket 18. A lower liner seal 30 is provided in a lower groove on the external surface of the cylinder liner 16, to seal between a lower portion of the cylinder liner 16 and the water jacket 18. A second lower liner seal 36 may be provided in a second lower groove on the external surface of the cylinder liner 16, to seal between a lower portion of the cylinder liner 16 and the engine frame 14.

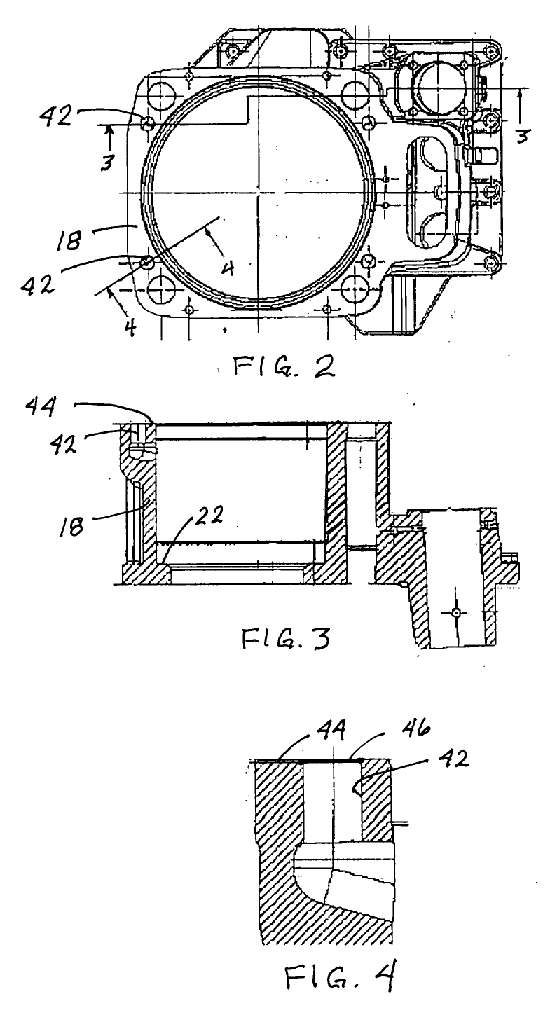

As shown in FIG. 2, the water jacket 18 has a plurality of coolant ports 42 therein. These coolant ports align with matching ports in the surface of the cylinder head 12, without passing through the cylinder liner 16. FIG. 3 shows the connection of these coolant ports 42 with the inner surface of the water jacket 18, which forms the coolant passage 32 between the water jacket 18 and the cylinder liner 16. The upper surface 44 of the water jacket 18 abuts the lower surface of the cylinder head 12. FIG. 4 shows more detail of a coolant port 42. A seal 46 is provided at the mating line between the cylinder head 12 and the water jacket 18. This seal 46 acts to seal the coolant port 42 against leakage of coolant, separately from the head gasket. This separate sealing between the water jacket 18 and the cylinder head 12 eliminates coolant leakage which could otherwise occur as a result of wear of the head gasket.

While the particular invention as herein shown and disclosed in detail is fully capable of obtaining the objects and providing the advantages hereinbefore stated, it is to be understood that this disclosure is merely illustrative of the presently preferred embodiments of the invention and that no limitations are intended other than as described in the appended claims.

We claim:

1. An apparatus for use in a locomotive diesel engine having an engine frame and a cylinder liner, said apparatus comprising:
a water jacket interposable between a cylinder liner and an engine frame; and
a liner abutment surface on said water jacket, said liner abutment surface being adapted to abut and support a cylinder liner.

2. The apparatus recited in claim 1, for use in a locomotive diesel engine having a cylinder head, said apparatus further comprising:
an upper end of said water jacket positionable adjacent a cylinder head of an engine; and
a coolant port in said upper end of said water jacket, said coolant port being adapted to conduct coolant directly between said water jacket and a cylinder head.

3. The apparatus recited in claim 2, further comprising a coolant port seal surrounding said coolant port, said coolant port seal being adapted to seal coolant flow between said water jacket and a cylinder head, separately from any other seal between said water jacket and a cylinder head.

4. An apparatus for use in a locomotive diesel engine having an engine frame and a water jacket, said apparatus comprising:
a cylinder liner interposable within a water jacket of an engine; and
a water jacket abutment surface on said liner, said water jacket abutment surface being adapted to abut a water jacket for support of said cylinder liner.

5. The apparatus recited in claim 4, for use in a locomotive diesel engine having a piston with a top piston ring, said apparatus further comprising:
a coolant passage on an external surface of said cylinder liner; and
an upper extension of said coolant passage adjacent a topmost position of a top piston ring in said cylinder liner.

6. A cylinder assembly, for use in a locomotive diesel engine having an engine frame, a cylinder head, and a piston with a top piston ring, said cylinder assembly comprising:
a cylinder liner defining a cylinder, said cylinder being adapted to receive a piston, said cylinder liner having an upper end positionable adjacent a cylinder head of an engine;
a water jacket surrounding said cylinder liner, said water jacket being interposable between said cylinder liner and an engine frame, said water jacket having an upper end positionable adjacent a cylinder head of an engine, said cylinder liner being supported by said water jacket; and
a coolant passage between said water jacket and said cylinder liner, said coolant passage being adapted to expose an outer surface of said cylinder liner to coolant adjacent a topmost position of a top piston ring in said cylinder;
a coolant port in said upper end of said water jacket adapted to conduct coolant directly between said water jacket and a cylinder head; and
a coolant port seal surrounding said coolant port, said coolant port seal being adapted to seal coolant flow between said water jacket and a cylinder head, separately from any other seal between said water jacket and a cylinder head.

7. The cylinder assembly recited in claim 6, further comprising an internal flange on said water jacket, said internal flange being interposable between said cylinder liner and an engine frame to support said cylinder liner.

8. The cylinder assembly recited in claim 7, further comprising an external shoulder on said cylinder liner, said external shoulder being adapted to abut said internal flange on said water jacket to support said cylinder liner.

9. The cylinder assembly recited in claim 6, further comprising a fire ring interposable between said upper end of said cylinder liner and a cylinder head, said fire ring being positionable adjacent said cylinder.

10. The cylinder assembly recited in claim 6, further comprising a coolant baffle in said coolant passage.

11. The cylinder assembly recited in claim 10, wherein said coolant baffle is attached to said outer surface of said cylinder liner.

12. The cylinder assembly recited in claim 6, further comprising an upper liner seal interposable between said cylinder liner and said water jacket, said upper liner seal being positionable above said coolant passage.

13. The cylinder assembly recited in claim 12, further comprising an upper groove in said outer surface of said cylinder liner, said upper groove being adapted to receive said upper liner seal.

14. The cylinder assembly recited in claim 6, further comprising a lower liner seal interposable between said cylinder liner and an engine frame, said lower liner seal being positionable below said coolant passage.

15. The cylinder assembly recited in claim 14, further comprising a lower groove in said outer surface of said cylinder liner, said lower groove being adapted to receive said lower liner seal.

16. A locomotive diesel engine, comprising:
an engine frame;
a cylinder head;
a cylinder liner defining a cylinder; and
a water jacket surrounding said cylinder liner, said water jacket being interposable between said cylinder liner and said engine frame, said cylinder liner being supported by said water jacket.

17. The engine recited in claim 16, further comprising an internal flange on said water jacket, said internal flange being interposable between said cylinder liner and said engine frame to support said cylinder liner.

18. The engine recited in claim 17, further comprising an external shoulder on said cylinder liner, said external shoulder being adapted to abut said internal flange on said water jacket to support said cylinder liner.

19. The engine recited in claim 16, further comprising:
a piston positionable within said cylinder, said piston having a top piston ring; and
a coolant passage between said water jacket and said cylinder liner, said coolant passage being adapted to expose an outer surface of said cylinder liner to coolant adjacent a topmost position of said top piston ring.

20. The engine recited in claim 19, further comprising a coolant baffle in said coolant passage.

21. The engine recited in claim 20, wherein said coolant baffle is attached to said outer surface of said cylinder liner.

22. The engine recited in claim 19, further comprising an upper liner seal interposable between said cylinder liner and said water jacket, said upper liner seal being positionable above said coolant passage.

23. The engine recited in claim 22, further comprising an upper groove in said outer surface of said cylinder liner, said upper groove being adapted to receive said upper liner seal.

24. The engine recited in claim 19, further comprising a lower liner seal interposable between said cylinder liner and an engine frame, said lower liner seal being positionable below said coolant passage.

25. The engine recited in claim 24, further comprising a lower groove in said outer surface of said cylinder liner, said lower groove being adapted to receive said lower liner seal.

26. The engine recited in claim 16, further comprising:
an upper end on said water jacket positionable adjacent said cylinder head;
a coolant port in said upper end of said water jacket adapted to conduct coolant directly between said water jacket and said cylinder head; and
a coolant port seal surrounding said coolant port, said coolant port seal being adapted to seal coolant flow between said water jacket and said cylinder head, separately from any other seal between said water jacket and said cylinder head.
